(19) United States
(12) Patent Application Publication
(10) Pub. No.: US 2026/0295860 A1
(43) Pub. Date: Oct. 1, 2026

(54) ROBOTIC FOOT SENSOR

(71) Applicant: Boston Dynamics, Inc., Waltham, MA (US)

(72) Inventors: Joao Luiz Almeida de Souza Ramos, Arlington, MA (US); Kevin Genehyub Gim, Burlington, MA (US); Ian Taylor, Cambridge, MA (US); Alberto Rodriguez, Cambridge, MA (US); Steven Potter, Waltham, MA (US)

(73) Assignee: Boston Dynamics, Inc., Waltham, MA (US)

(21) Appl. No.: 19/423,173

(22) Filed: Dec. 17, 2025

Related U.S. Application Data
(60) Provisional application No. 63/780,618, filed on Mar. 31, 2025.

(51) Int. Cl. B25J 13/08; B25J 9/00; B25J 9/16; B62D 57/032

(52) U.S. Cl. CPC B25J 13/084; B25J 9/0009; B25J 9/1653; B25J 9/1674; B25J 13/087; B62D 57/032

(57) ABSTRACT

A robotic foot sensor for a mobile robot is described. The robotic foot sensor includes a member including a set of passive sensing elements, and a set of active sensors communicatively coupled to the set of passive sensing elements.

### CROSS-REFERENCE TO RELATED APPLICATIONS

This application claims the benefit under 35 U.S.C. § 119(e) of U.S. Provisional application serial number 63/780,618, filed Mar 31, 2025, titled, “ROBOTIC FOOT SENSOR,” the entire contents of which is incorporated by reference herein.

### FIELD OF THE INVENTION

This disclosure relates generally to robotics and more specifically to systems, methods and apparatuses for providing sensing functionality to a robotic foot.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

Mobile legged robots (e.g., bipeds, quadrupeds) may include sensors to determine contact forces between their legs and/or feet and the environment (e.g., ground and other objects). Some conventional legged robots (e.g., humanoid robots) include force-torque sensors in their feet to regulate the contact forces with the environment to enable the robot to perform various tasks (e.g., walking, running, jumping, etc.). Force-torque sensors may also be used to estimate the pose of the robot. Force-torque sensors are often costly, heavy, challenging to maintain and calibrate, fragile, and/or difficult to mass produce, which may limit their widespread use in low-cost legged robots for large-scale production. The inventors have recognized and appreciated that a legged robot may be designed to include robotic feet that do not use force-torque sensors when the robot is able to sense the torque produced by its joints with high precision. For instance, such joint torque measurements may be used in combination with contact data sensed by a set of tactile sensing (e.g., contact sensing) units arranged in and/or configured to be coupled to a robotic foot to regulate the contact forces between the robotic foot and the environment. To this end, some embodiments of the present disclosure relate to a robotic foot sensor that includes a set of tactile sensing units. Deformations of a flexure included within the robotic foot sensor as a result of the robotic foot contacting the environment may be sensed by the tactile sensing units to determine a distribution of forces acting on and/or a normal/shear pressure distribution across a contact patch of the robotic foot. Some embodiments further include an inertial measurement unit (IMU) configured to estimate the velocity and/or acceleration of the robotic foot, which may be used in combination with tactile sensing data from the robotic foot sensor to characterize an interaction between the robotic foot and the environment, such as whether the foot is slipping, firmly contacting the ground, or bumping into an object.

In some embodiments, the invention features a robotic foot sensor. The robotic foot sensor includes a member including a set of passive sensing elements, and a set of active sensors communicatively coupled to the set of passive sensing elements.

In one aspect, the set of active sensors is arranged outside of a load path experienced by the set of passive sensing elements. In another aspect, the robotic foot sensor further includes an inertial measurement unit, and at least one computer processor configured to characterize an interaction of a robotic foot including the robotic foot sensor and a surface based, at least in part, on a first output of the inertial measurement unit and a second output of the set of active sensors. In another aspect, the interaction of the robotic foot and the surface comprises a determination of whether the robotic foot is slipping on the surface. In another aspect, the interaction of the robotic foot and the surface comprises a determination of whether the robotic foot has contacted an object and/or a partial foothold on the surface. In another aspect, the member includes a set of protrusions, each protrusion in the set of protrusions including a passive sensing element of the set of passive sensing elements. In another aspect, the set of protrusions is arranged in an array pattern on a surface of the member. In another aspect, the set of protrusions is arranged in a staggered pattern on a surface of the member. In another aspect, the set of protrusions is arranged along an edge portion of the member. In another aspect, the member comprises a polymer. In another aspect, the member is configured to be separable from the set of active sensors. In another aspect, the robotic foot sensor further includes a rigid plate arranged between the set of passive sensing elements and the set of active sensors.

In another aspect, the set of passive sensing elements includes a set of magnets arranged in the member, and the set of active sensors comprises a set of magnetic sensors. In another aspect, the member includes a set of protrusions, each protrusion in the set of protrusions including a magnet in the set of magnets. In another aspect, the set of magnetic sensors includes a set of Hall sensors. In another aspect, the set of magnetic sensors is configured to sense a change in a magnetic field generated by the set of magnets in response to deformation of a flexure coupled to the member. In another aspect, the robotic foot sensor further includes a magnetic shield formed around at least a portion of each magnet in the set of magnets. In another aspect, the robotic foot sensor further includes a magnetic shield formed around at least a portion of the set of magnetic sensors.

In another aspect, the set of passive sensing elements includes a set of fluid gaps arranged in the member, and the set of active sensors comprises a set of pressure sensors communicatively coupled to the set of fluid gaps. In another aspect, the member includes a set of protrusions, each protrusion in the set of protrusions including a fluid gap in the set of fluid gaps. In another aspect, the set of fluid gaps comprises a set of air gaps. In another aspect, the set of pressure sensors is configured to sense a change in a pressure within the set of fluid gaps in response to deformation of a flexure coupled to the member. In another aspect, the robotic foot sensor further includes a printed circuit board on which the set of pressure sensors is arranged.

In another aspect, the set of passive sensing elements includes a set of metal pieces arranged in the member, and the set of active sensors comprises a set of coils communicatively coupled to the set of metal pieces. In another aspect, the member includes a set of protrusions, each protrusion in the set of protrusions including a metal piece in the set of metal pieces. In another aspect, the set of active sensors is configured to sense a change in inductance created in response to deformation of a flexure coupled to the member. In another aspect, the set of active sensors is configured to sense a change in capacitance created in response to deformation of a flexure coupled to the member.

In another aspect, the set of passive sensing elements includes a set of load cells, and the set of active sensors comprises a set of amplifiers coupled to the set of load cells. In another aspect, the robotic foot sensor further includes a set of friction elements coupled to the set of load cells. In another aspect, each load cell in the set of load cells includes a substrate coupled to a friction element in the set of friction elements. In another aspect, the set of load cells comprises a set of full bridge load cells.

In another aspect, the set of passive sensing elements includes first tactile sensing elements having a first sensing modality and second tactile sensing elements having a second sensing modality different from the first sensing modality. In another aspect, the first tactile sensing elements comprise a set of load cells. In another aspect, the second tactile sensing elements comprise a set of magnets. In another aspect, the second tactile sensing elements comprise a set of fluid gaps arranged in the member. In another aspect, a number of load cells in the set of load cells is less than a number of second tactile sensing elements. In another aspect, a first portion of the set of active sensors is arranged between the set of load cells and the second tactile sensing elements. In another aspect, the first portion of the set of active sensors comprises a set of magnetic sensors. In another aspect, the robotic foot sensor further includes a sole mount arranged between the first tactile sensing elements and the second tactile sensing elements, the sole mount mechanically coupled to the member. In another aspect, the member comprises a tread.

In some embodiments, the invention features a method of sensing forces applied to a robotic foot of a robot. The method includes receiving, by set of active sensors communicatively coupled to a set of passive sensing elements arranged in a member, tactile sensor data, and determining, based on the tactile sensor data, a distribution of forces applied to the set of passive sensing elements by an environment in contact with the member.

In one aspect, the method further includes controlling the robot to perform an action based, at least in part, on the distribution of forces. In another aspect, the set of active sensors are arranged outside of a load path experienced by the set of passive sensing elements. In another aspect, the method further includes characterizing, by at least one computer processor, an interaction of the robotic foot and a surface based, at least in part, on a first output of an inertial measurement unit and a second output of the set of active sensors, and controlling the robot to perform an action based, at least in part on the interaction of the robotic foot and the surface. In another aspect, characterizing the interaction of the robotic foot and the surface comprises determining whether the robotic foot is slipping on the surface. In another aspect, characterizing the interaction of the robotic foot and the surface comprises determining whether the robotic foot has contacted an object and/or a partial foothold on the surface. In another aspect, the set of passive sensing elements includes first tactile sensing elements having a first sensing modality and second tactile sensing elements having a second sensing modality different from the first sensing modality.

In some embodiments, the invention features a robotic foot for a legged robot, the robotic foot including a robotic foot structure including a set of active sensors, and a member coupled to the robotic foot structure, the member including a set of passive sensing elements communicatively coupled to the set of active sensors.

In one aspect, the set of active sensors is arranged outside of a load path experienced by the set of passive sensing elements. In another aspect, the robotic foot further includes an inertial measurement unit, and at least one computer processor configured to characterize an interaction of the robotic foot and a surface based, at least in part, on a first output of the inertial measurement unit and a second output of the set of active sensors. In another aspect, the interaction of the robotic foot and the surface comprises a determination of whether the robotic foot is slipping on the surface. In another aspect, the interaction of the robotic foot and the surface comprises a determination of whether the robotic foot has contacted an object and/or a partial foothold on the surface. In another aspect, the member includes a set of protrusions, each protrusion in the set of protrusions including a passive sensing element of the set of passive sensing elements. In another aspect, the set of protrusions is arranged in an array pattern on a surface of the member. In another aspect, the set of protrusions is arranged in a staggered pattern on a surface of the member. In another aspect, the set of protrusions is arranged along an edge portion of the member. In another aspect, the member comprises a polymer. In another aspect, the member is configured to be separable from the robotic foot structure. In another aspect, the robotic foot further includes a rigid plate arranged between the set of passive sensing elements and the set of active sensors.

In another aspect, the set of passive sensing elements includes a set of magnets arranged in the member, and the set of active sensors comprises a set of magnetic sensors. In another aspect, the member includes a set of protrusions, each protrusion in the set of protrusions including a magnet in the set of magnets. In another aspect, the set of magnetic sensors includes a set of Hall sensors. In another aspect, the set of magnetic sensors is configured to sense a change in a magnetic field generated by the set of magnets in response to deformation of a flexure coupled to the member. In another aspect, the robotic foot further includes a magnetic shield formed around at least a portion of each magnet in the set of magnets. In another aspect, the robotic foot further includes a magnetic shield formed around at least a portion of the set of magnetic sensors.

In another aspect, the set of passive sensing elements includes a set of fluid gaps arranged in the member, and the set of active sensors comprises a set of pressure sensors communicatively coupled to the set of fluid gaps. In another aspect, the member includes a set of protrusions, each protrusion in the set of protrusions including a fluid gap in the set of fluid gaps. In another aspect, the set of fluid gaps comprises a set of air gaps. In another aspect, the set of pressure sensors is configured to sense a change in a pressure within the set of fluid gaps in response to deformation of a flexure coupled to the member. In another aspect, the robotic foot further includes a printed circuit board on which the set of pressure sensors is arranged.

In another aspect, the set of passive sensing elements includes a set of metal pieces arranged in the member, and the set of active sensors comprises a set of coils communicatively coupled to the set of metal pieces. In another aspect, the member includes a set of protrusions, each protrusion in the set of protrusions including a metal piece in the set of metal pieces. In another aspect, the set of active sensors is configured to sense a change in inductance created in response to deformation of a flexure coupled to the member. In another aspect, the set of active sensors is configured to sense a change in capacitance created in response to deformation of a flexure coupled to the member.

In another aspect, the set of passive sensing elements includes a set of load cells, and the set of active sensors comprises a set of amplifiers coupled to the set of load cells. In another aspect, the robotic foot further includes a set of friction elements coupled to the set of load cells. In another aspect, each load cell in the set of load cells includes a substrate coupled to a friction element in the set of friction elements. In another aspect, the set of load cells comprises a set of full bridge load cells.

In another aspect, the set of passive sensing elements includes first tactile sensing elements having a first sensing modality and second tactile sensing elements having a second sensing modality different from the first sensing modality. In another aspect, the first tactile sensing elements comprise a set of load cells. In another aspect, the second tactile sensing elements comprise a set of magnets. In another aspect, the second tactile sensing elements comprise a set of fluid gaps arranged in the member. In another aspect, a number of load cells in the set of load cells is less than a number of second tactile sensing elements. In another aspect, a first portion of the set of active sensors is arranged between the set of load cells and the second tactile sensing elements. In another aspect, the first portion of the set of active sensors comprises a set of magnetic sensors. In another aspect, the robotic foot further includes a sole mount arranged between the first tactile sensing elements and the second tactile sensing elements, the sole mount mechanically coupled to the member. In another aspect, the member comprises a tread.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates an example configuration of a robotic device, according to an illustrative embodiment of the invention.

FIG. 2A illustrates an example of a humanoid robot, according to an illustrative embodiment of the invention.

FIG. 2B illustrates an example of a humanoid robot having two robotic feet, according to an illustrative embodiment of the invention.

FIG. 3 is a schematic illustration of components of a robotic foot sensor, according to an illustrative embodiment of the invention.

FIGS. 4A and 4B are respective isometric and side views of a robotic foot sensor, according to an illustrative embodiment of the invention.

FIGS. 4C-4E illustrate different patterns of a set of protrusions on a member of a robotic foot sensor, according to an illustrative embodiment of the invention.

FIG. 5A schematically illustrates a robotic foot sensor including a set of magnetic sensors, according to an illustrative embodiment of the invention.

FIG. 5B schematically illustrates components of a magnetic sensor unit of the set of magnetic sensors shown in FIG. 5A, according to an illustrative embodiment of the invention.

FIG. 6A schematically illustrates a robotic foot sensor including a set of pressure sensors, according to an illustrative embodiment of the invention.

FIG. 6B schematically illustrates components of a pressure sensor unit of the set of pressure sensors shown in FIG. 6A, according to an illustrative embodiment of the invention.

FIG. 7A schematically illustrates a robotic foot sensor including a set of load cell sensor units, according to an illustrative embodiment of the invention.

FIG. 7B schematically illustrates components of a load cell sensor unit of the set of load cell sensors shown in FIG. 7A, according to an illustrative embodiment of the invention.

FIG. 8 is an exploded view of a robotic foot sensor, according to an illustrative embodiment of the invention.

FIG. 9 is a flowchart of an exemplary method of sensing forces applied to a robotic foot, according to an illustrative embodiment of the invention.

### DETAILED DESCRIPTION

Information describing how one or more feet of a legged robot (e.g., a humanoid robot) are contacting the environment may be important to ensure that the robot can maintain balance, locomote throughout the environment, and/or perform various tasks. Force-torque sensors used in some conventional legged robots to provide foot contact information are costly, heavy, fragile, and/or are not easily repairable if the sensors are damaged. Additionally, some force-torque sensors suffer from inertial effects by sensing the mass of the foot being accelerated and/or only provide the net force/torque on the foot, which may limit their ability to sense a partial contact of a foot with a surface. Some embodiments of the present disclosure are directed to robotic foot sensors that include a set of tactile sensing units configured to determine a distribution of forces on a robotic foot when contacting the environment. In some embodiments, the set of tactile sensing units includes a set of passive sensing units arranged in a member of the robotic foot sensor and a set of active sensing elements (e.g., sensor transducers). The set of passive sensing elements may be configured to have mechanical forces applied to them, and the set of active sensing elements may be configured to sense a deformation in a flexure coupled to the set of passive sensing elements when the mechanical forces are applied thereto. The robotic foot sensor may be configured to arrange the set of active sensing units out of the load path of the robotic foot sensor to provide improved durability for the robotic foot sensor, and to arrange the set of passive sensing units in a member (e.g., a replaceable member), to facilitate repair and/or maintenance of the sensor. An example of such a member is described herein as a “tread.” It should be appreciated, however, that other members are also suitable. A robotic foot sensor according to some embodiments may include an internal measurement unit (IMU) that may be used in combination with the distribution of forces determined from the set of tactile sensing units to characterize interactions (e.g., foot slipping) between a robotic foot and the environment, such that the posture and/or movement of the robot may be controlled to mitigate undesired interactions. Additionally, a robot including a robotic foot sensor designed in accordance with the techniques described herein may have enhanced movement capabilities that enable the robot to navigate and perform tasks in environments having a wide range of surface characteristics (e.g., sandy beaches, concrete floors, rocky hills, small surfaces such as narrow beams, edges of steps, etc.). For instance, the distribution of forces acting on the robotic foot sensor may indicate a particular portion of the foot contacting a ground surface or object in the environment, which may impact control decisions on how the robot should move next to satisfy an objective.

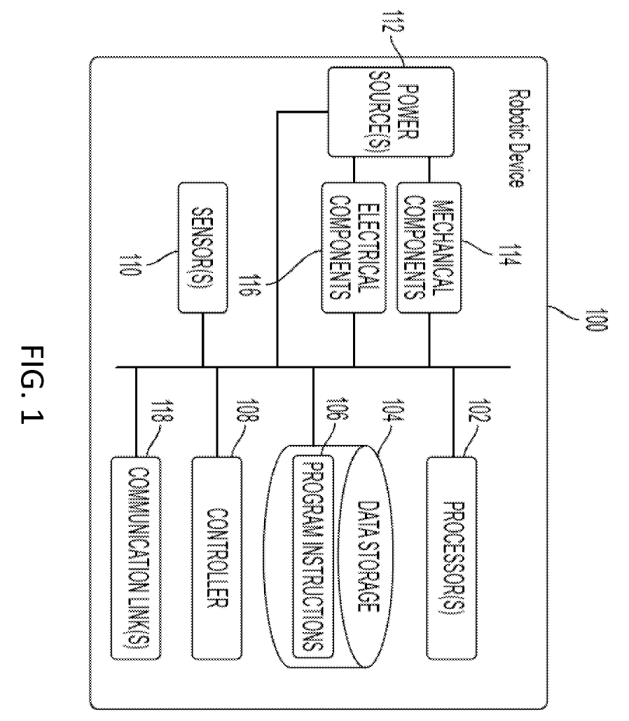

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

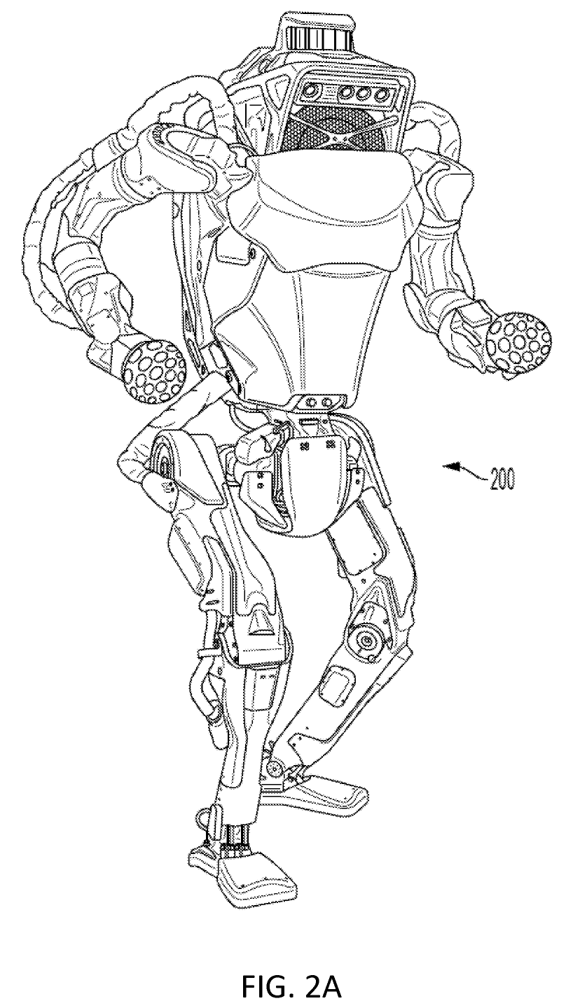

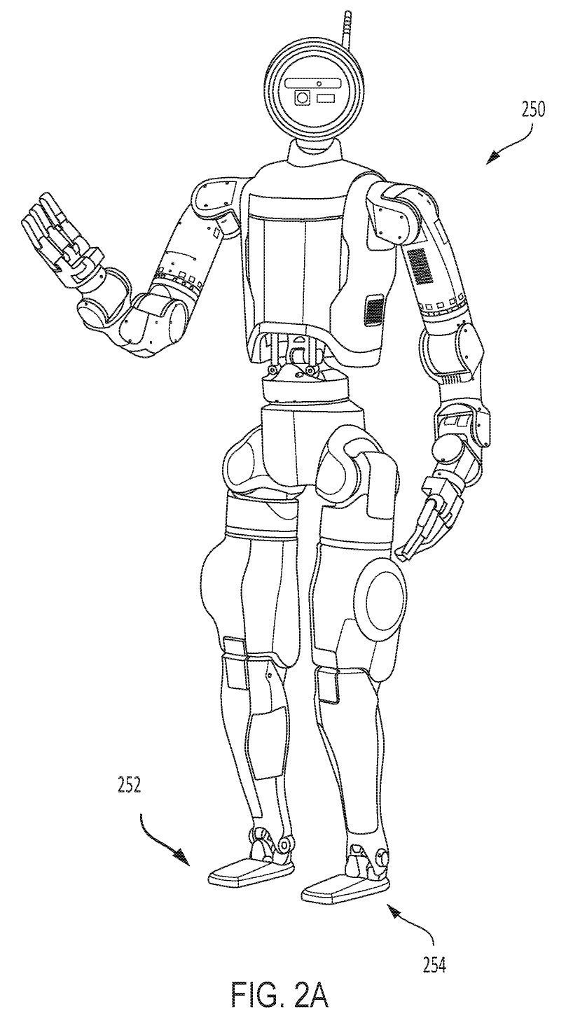

FIG. 2A illustrates an example of a humanoid robot, according to an illustrative embodiment of the invention. The robotic device 200 may correspond to the robotic device 100 shown in FIG. 1. The robotic device 200 serves as a possible implementation of a robotic device that may be configured to include the systems and/or carry out the methods described herein. Other example implementations of robotic devices may exist.

The robotic device 200 may include a number of articulated appendages, such as robotic legs and/or robotic arms. Each articulated appendage may include a number of members connected by joints that allow the articulated appendage to move through certain degrees of freedom. Each member of an articulated appendage may have properties describing aspects of the member, such as its weight, weight distribution, length, and/or shape, among other properties. Similarly, each joint connecting the members of an articulated appendage may have known properties, such as the degrees of its range of motion the joint allows, the size of the joint, and the distance between members connected by the joint, among other properties. A given joint may be a joint allowing one degree of freedom (e.g., a knuckle joint or a hinge joint), a joint allowing two degrees of freedom (e.g., a cylindrical joint), a joint allowing three degrees of freedom (e.g., a ball and socket joint), or a joint allowing four or more degrees of freedom. A degree of freedom may refer to the ability of a member connected to a joint to move about a particular translational or rotational axis.

The robotic device 200 may also include sensors to measure the angles of the joints of its articulated appendages. In addition, the articulated appendages may include a number of actuators that can be controlled to extend and retract members of the articulated appendages. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

The robotic device 200 may be configured to send sensor data from the articulated appendages to a device coupled to the robotic device 200 such as a processing system, a computing system, or a control system. The robotic device 200 may include a memory, either included in a device on the robotic device 200 or as a standalone component, on which sensor data is stored. In some implementations, the sensor data is retained in the memory for a certain amount of time. In some cases, the stored sensor data may be processed or otherwise transformed for use by a control system on the robotic device 200. In some cases, the robotic device 200 may also transmit the sensor data over a wired or wireless connection (or other electronic communication means) to an external device.

FIG. 2B illustrates an example of a humanoid robot 250 having two robotic feet 252, 254, according to an illustrative embodiment of the invention. In FIG. 2B, the robotic feet 252, 254 are connected to the humanoid robot 250 (e.g., mechanically, electrically, and/or communicatively) and function as a contact surface of the robot 250 with its environment. Each robotic foot 252, 254 includes a robotic foot sensor and can function as described in greater detail below.

Robotic feet (robotic feet 252, 254) of a robot (e.g., humanoid robot 250) may contact an environment (e.g., the ground, an object) to enable the robot to interact with the environment. Sensors within a robotic foot may be used to sense contact forces between the foot and the environment to enable the robot to complete movements (e.g., walking, jumping, etc.) while maintaining balance. Sensor data received from the robotic foot sensors may also be used to estimate the pose of the robot, which may be useful in planning movements of the robot. A control system of the robot may receive input from the robotic foot sensors and provide control commands to actuators in the robot to move portions of the robot to maintain balance and/or perform one or more movements that enable the robot to complete one or more tasks.

As described above, some conventional robotic feet include force-torque sensors configured to sense the wrench applied to the foot from the environment. Due to the high forces experienced by the feet of the robot when performing movements, force-torque sensors are susceptible to damage due to repeated use, resulting in the need for frequent replacement and/or conservative movements to avoid damage to the sensors. Additionally, such force-torque sensors are costly and relatively heavy, which may create phantom inertial forces and increase leg inertia due to distal placement of the sensors in the limb. The inventors have recognized and appreciated that the use of force-torque sensors as robotic foot sensors may not be necessary for robot designs in which the torque produced at the robot’s joints can be determined with high precision. Rather, a simplified, lightweight, less expensive and/or more robust robotic foot sensor may be produced by substituting a set of tactile sensing units for the force-torque sensor used in conventional robot foot sensor designs. Sensor data received from the robotic foot sensors can be used in combination with information about the torques generated at the robotic joints to regulate the contact forces between the robotic feet and the environment.

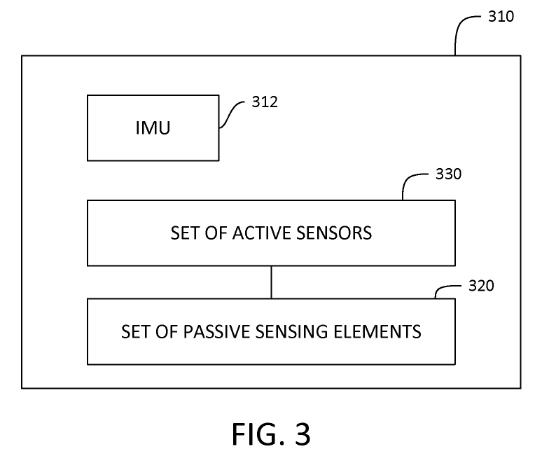

FIG. 3 is a schematic illustration of an example robotic foot sensor 310, in accordance with some embodiments of the present disclosure. Robotic foot sensor 310 includes an inertial measurement unit (IMU) 312 configured to estimate the velocity and/or acceleration of the robotic foot within which robotic foot sensor 310 is arranged. Robotic foot sensor 310 further includes a set of passive sensing elements 320 and a set of active sensors 330 communicatively coupled to the set of passive sensing elements 320. Collectively, a passive sensing element 320 and a corresponding active sensor 330 may be considered a tactile sensing unit. In some embodiments, the output of the IMU 312 may be used in combination with data sensed by the set of active sensors 330 to estimate information about an interaction between the robotic foot and the environment. For example, the information from IMU 312 and the set of active sensors 330 may be used to detect robotic foot slipping or contact of the robotic foot with an object. As discussed in detail below, contact patches corresponding to a subset of the tactile sensing units may be used to provide information about the portion of the foot that is in contact with a surface, which may further inform a controller of the robot about the current pose and/or interaction state of the robotic foot with the environment.

Some robots incorporate tactile sensing elements in their end effectors to perform dexterous manipulation of objects. Such tactile sensing elements obtain high sensitivity and/or accuracy by loading a set of sensor transducers (e.g., pressure sensors, force sensing resistors). While such components may work well in end effector applications in which the forces exerted by a manipulated object on the end effector are small, the use of sensor transducers designed for end effector applications may not work as well in a robotic foot due to the substantially larger forces and impacts experienced by the robotic foot during operation of the robot. Additionally, a robotic foot is susceptible to a considerable amount of wear and tear caused by friction of the robotic foot with the environment and/or stepping on wet surfaces or debris, which may not be present in end effector applications of tactile sensing units.

The inventors have recognized that the high sensitivity and/or accuracy that may be helpful in performing dexterous manipulation by a robotic end effector may not be required when tactile sensing is used in a robotic foot sensor. Rather, to improve the robustness and/or ease of maintenance and/or replaceability of the robotic foot sensor, some embodiments arrange the sensor transducer configured to perform the sensing (also referred to herein as an “active sensor”) outside of a load path of the forces exerted on the robotic foot to indirectly sense changes in a physical quantity (e.g. magnetic field, electric field, inductance, pressure, etc.) as a result of contact between the robotic foot and the environment. Separating the set of passive sensing elements from the corresponding set of sensor transducers enables the set of passive sensing elements to be included in a member that can be removed and replaced from the robotic foot, when needed or desired. For instance, different treads (having the same or different type of passive sensing elements) may be used by a robot depending on different environmental conditions that the robot is expected to encounter. As one example, a first type of tread may be used when the robot is expected to encounter slippery environmental surfaces, a second type of tread may be used when the robot is expected to encounter grippy environmental surfaces, and a third type of tread may be used when the robot is expected to encounter rough environmental surfaces.

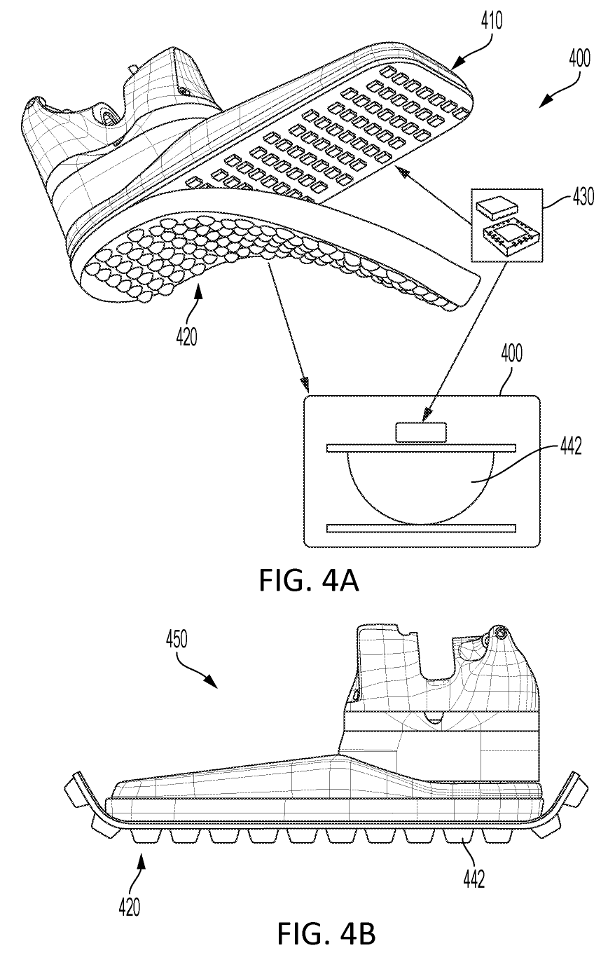

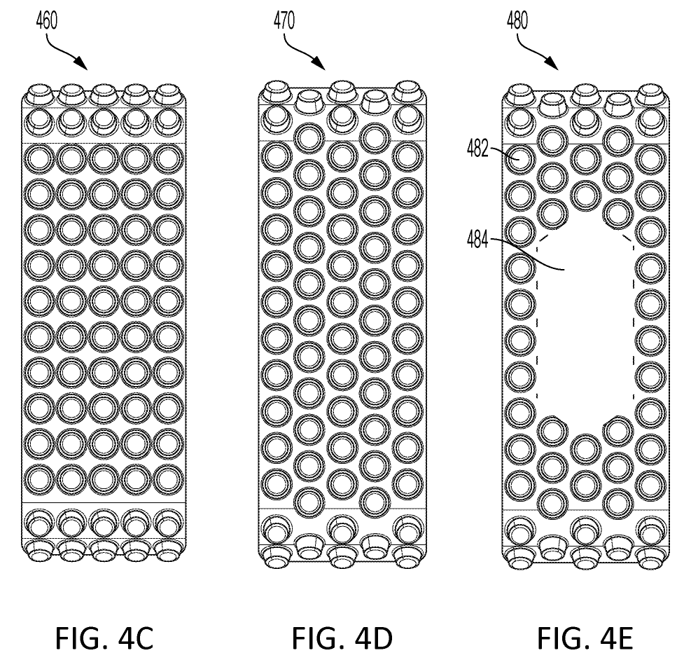

FIG. 4A schematically illustrates a robotic foot sensor 400, in accordance with some embodiments of the present disclosure. As shown, robotic foot sensor 400 includes a foot structure 410 and a tread 420. Foot structure 410 includes a set of active sensors 430 coupled thereto. As described herein, active sensor 430 may include a sensor transducer configured to sense a change in deformation of a flexure associated with tread 420 when the tread 420 contacts a surface such as the ground. Active sensor 430 may be electrically coupled to electronics configured to drive active sensor 430 to perform sensing. By sensing the change in deformation of the flexure, each active sensor 430 in the set of active sensors may be arranged outside of a load path of forces (e.g., contact forces, shear forces) experienced by the robotic foot when the tread 420 is in contact with the environment. As described herein, active sensor 430 may be configured to indirectly sense a change in deformation of a flexure associated with tread 420 using any suitable sensing modality examples of which include, but are not limited to, detecting a change in an electric or magnetic field, detecting a change in pressure, detecting a change in inductance, or detecting a change in conductance.

In some embodiments, tread 420 comprises a polymer having high durability (e.g., high tear strength, resistance to wear). Such polymer materials are not typically used with tactile sensors included in robotic end effectors due to the lack of compliance of such materials, which may be desired to securely grasp objects. The inventors have recognized that robotic foot sensors may not require the use of materials with high compliance typically used in robotic end effector applications. In some embodiments, tread 420 includes a set of protrusions 442 or “knubs” within which a corresponding tactile sensing element may be arranged (e.g., embedded). When considered together, a passive sensing element arranged in a protrusion 442, a flexure that is compressed when the passive sensing element contacts a surface, and a corresponding active sensor 430 configured to sense deformation of the flexure may form a tactile sensing unit 440 configured to indirectly sense forces associated with contact of protrusion 422 of tread 420 with the surface. The passive sensing element in each protrusion 422 may be configured to sense forces applied to the protrusion independent of forces applied to neighboring protrusions in the set of protrusions of the tread 420. The independent sensing capabilities of each of the tactile sensing units 440 may simplify the calibration of the tactile sensing units. For example, in some implementations, if a single tactile sensing unit is calibrated, the remaining tactile sensing units may be calibrated using the same or similar calibration parameters.

Unlike conventional force-torque sensors, which detect a net force applied to the robotic foot, some embodiments of the present disclosure include a set of tactile sensing units 440 arranged in an array across all or a portion of the surface of tread 420. The output of the tactile sensing units 440 may provide a spatial distribution of force across the surface of tread 420. As described above, each of the tactile sensing units 440 may be configured to sense local forces on its associated protrusion with limited or no cross-talk with tactile sensing units 440 arranged in neighboring protrusions. Contact patches comprising measurements from a subset of the tactile sensing units 440 may be analyzed to determine whether portions of the robotic foot are slipping, whether a portion of the foot has contacted an object, or is overhanging a surface (such as when the robot is climbing stairs). In some embodiments, tread 420 is removable from foot structure 410 such that the tread 420 can be replaced when needed, for example, due to wear and tear of the tread 420 caused by repeated impacts with the environment.

FIG. 4B illustrates a side view of a robotic foot 450 including a robotic foot sensor (e.g., robotic foot sensor 400), in accordance with some embodiments of the present disclosure. As shown, the robotic foot sensor includes a tread 420 arranged on a bottom surface (e.g., sole) of robotic foot 450. Tread 420 may include a set of protrusions 442 within which are arranged a set of passive sensing elements, examples of which are described herein. A corresponding set of active sensors may be arranged on robotic foot 450, such that an active sensor and a corresponding passive sensing element form a tactile sensing unit configured to detect local changes in deformation of a flexure coupled to the set of protrusions 442 as described in connection with FIG. 4A. In some embodiments, tread 420 may extend beyond a lower surface of robotic foot 450. For example, as shown in FIG. 4B, tread 420 may extend beyond a front portion of robotic foot 450 and/or may extend beyond a rear portion of robotic foot 450. Extending tread 420 beyond the lower foot structure surface of the robotic foot 450 may, for example, facilitate removal and replacement of the tread 420 when needed or desired and/or allow the robot to use the front and back edges of the tread 420 while still measuring forces using the robotic foot sensor.

FIGS. 4C-4E schematically illustrate different patterns of a set of protrusions 442 arranged on the bottom surface of tread 420, in accordance with some embodiments of the present disclosure. FIG. 4C shows a first pattern 460 in which the set of protrusions are arranged in a grid or “array” of rows and columns. FIG. 4D shows a second pattern 470 in which the set of protrusions are provided in a “staggered” arrangement. The staggered arrangement shown in FIG. 4D may permit a finer resolution of force sensing along the length of the robotic foot and/or may be utilized to include a larger number of protrusions relative to the grid design shown in FIG. 4C due to reduced spacing between the protrusions. FIG. 4E shows a third pattern 480 in which the set of protrusions are present in a first portion 482 of the tread and are absent in a second portion 484 of the tread. For example, as shown in FIG. 4E, the first portion 482 may include the portion of the tread closest to the edges of the tread and the second portion 484 may include the center portion of the tread. The third pattern 480 may be desirable in some embodiments to reduce the number of tactile sensing units in the robotic foot sensor and/or to permit the use of different types of tactile sensing units within the foot sensor. Although only three patterns for the set of protrusions are shown in FIGS. 4C-4E it should be appreciated that any other suitable pattern may be used.

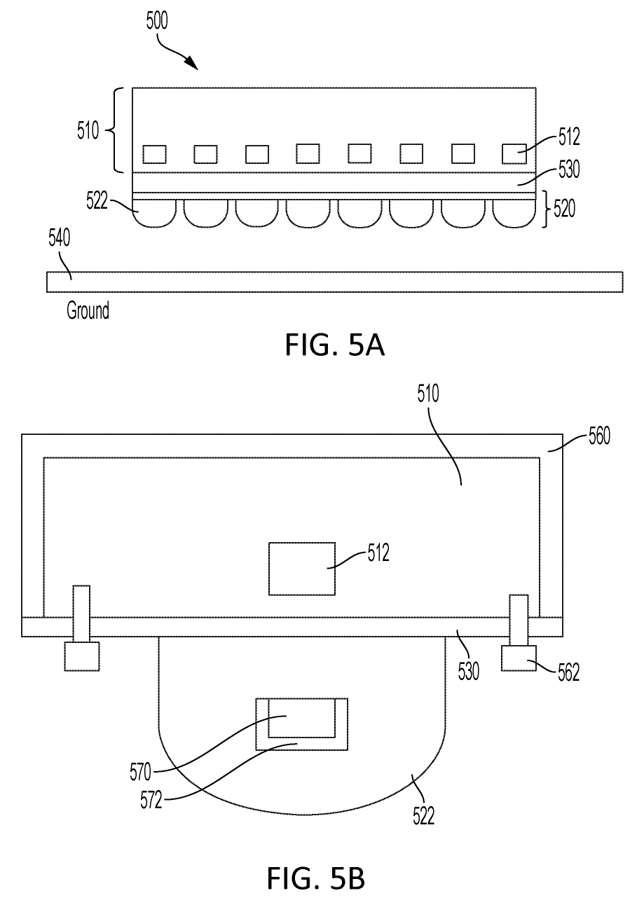

FIG. 5A schematically illustrates a robotic foot sensor 500 including magnetic sensing units, in accordance with some embodiments of the present disclosure. As shown, robotic foot sensor 500 includes a foot structure 510, a tread 520 and a rigid plate 530 coupled between the foot structure 510 and the tread 520. In some embodiments, rigid plate 530 may be coupled to foot structure 510 and tread 520 using an adhesive and/or one or more fasteners. In the example shown in FIG. 5B, rigid plate 530 is coupled to foot structure 510 using fasteners 562. Foot structure 510 includes a set of magnetic sensors 512. For example, magnetic sensors 512 may be implemented as one or more Hall sensors (e.g., one or more three-axis Hall sensors). In some embodiments, a single-axis Hall sensor may be used to sense z-motion of a magnet (e.g. magnet 570 shown in FIG. 5B). In other embodiments, multiple Hall sensors (e.g., multiple 3-axis Hall sensors) per magnet may be used to sense additional motions including in the x- and y-directions and/or the rotations of the magnet (e.g., tilt, roll, and yaw of the magnet). Tread 520 may include a set of protrusions 522 configured to contact a surface, such as ground 540.

As shown in FIG. 5B, at least some protrusions in the set of protrusions 522 may include a magnet 570 configured to generate a magnetic field that can be sensed by a corresponding magnetic sensor 512 in the set of magnetic sensors. In some embodiments, magnet 570 may be at least partially surrounded by a magnetic shield 572. Magnetic shield 572 may, for example, attenuate the magnetic field generated by magnet 570 in the direction of the surface of the protrusion 522 configured to contact the environment and/or redirect the magnetic field generated by the magnet 570 in the direction of the corresponding magnetic sensor 512. Magnetic shield 572 may also, for example, prevent individual sensing units from interfering with each other by reducing cross-talk between the sensed magnetic fields generated by the corresponding magnets 570. By reducing such interference, the magnets 570 of the sensing units may be arranged in closer proximity to each other, thereby providing for increased resolution of the robotic foot sensor. In some embodiments, magnetic shield 572 may be implemented as a steel cup partially surrounding magnet 570. Such magnetic shielding may be important, for example, to enable the robot to move effectively about environments having magnetic surfaces.

As also shown in FIG. 5B, foot structure 510 may include a magnetic shield 560 formed around a portion of magnetic sensor 512. Magnetic shield 560 may be arranged to attenuate magnetic signals generated from outside robotic foot sensor 500 from being sensed by magnetic sensor 512, thereby reducing external noise sensed by the magnetic sensor 512. For example, magnetic shield 560 may be configured to shield magnetic sensor 512 from electromagnetic environmental signals/noise (e.g., 60 Hz power line signals common in manufacturing environments). When protrusion 522 including magnet 570 contacts a surface (e.g., ground 540), a flexure associated with (e.g., coupled to and/or included within) the protrusion 522 may compress resulting in a change in the magnetic field sensed by magnetic sensor 512. The change in magnetic field sensed by magnetic sensor 512 may be used, at least in part, in some embodiments to determine a force acting on the protrusion 522 when contacting the environment. When considered across the set of magnetic force sensing units (each of which includes a magnet 570 and a corresponding magnetic sensor 512), a spatial distribution of forces acting on the foot sensor from the environment may be determined.

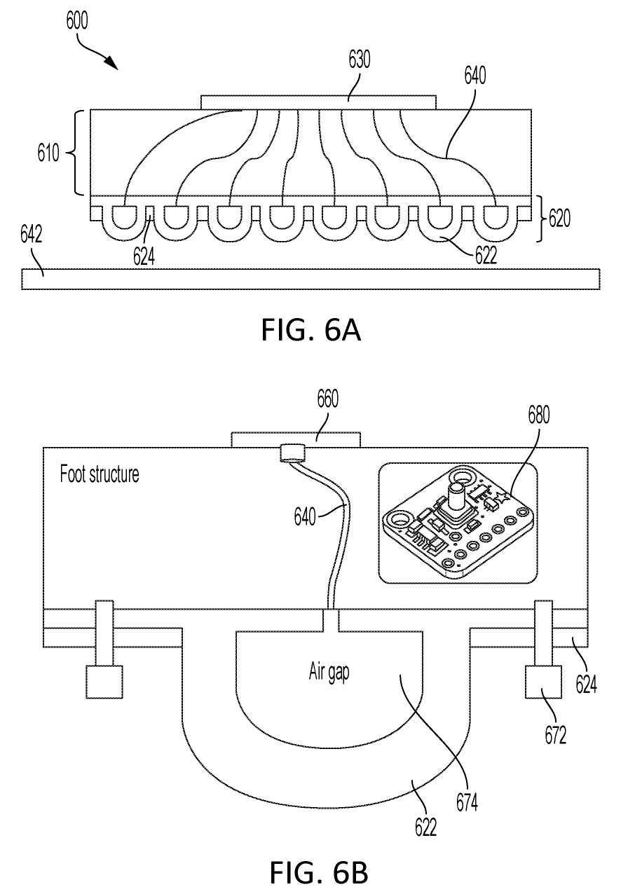

FIG. 6A schematically illustrates a robotic foot sensor 600 including pressure sensing units, in accordance with some embodiments of the present disclosure. As shown, robotic foot sensor 600 includes a foot structure 610 coupled to a tread 620. In some embodiments, foot structure 610 may be coupled to tread 620 using an adhesive and/or one or more fasteners. As shown in FIG. 6B, in some embodiments, foot structure 610 is coupled to tread 620 using fasteners 672 and a rigid structure 624. Rigid structure 624 may be arranged between protrusions 622 in a set of protrusions configured to contact a surface, such as ground 642. Foot structure 610 includes a set of pressure sensors 630 coupled to respective fluid gaps in the set of protrusions via fluidic connections 640. In some embodiments, the set of pressure sensors 630 may be implemented on a printed circuit board (PCB) 680 coupled to foot structure 610. PCB 680 may include electronics configured to drive pressure sensors 630.

As shown in FIG. 6B, at least some protrusions in the set of protrusions 622 may include a fluid gap 674 configured to contain a fluid (e.g., a liquid or a gas). In some embodiments, the fluid in the fluid gap 674 may be pressurized. In some embodiments, the fluid gap 674 may be implemented as an air gap with the fluid being air (pressurized or unpressurized). When protrusion 622 including fluid gap 674 contacts a surface (e.g., ground 642), the pressure within the fluid gap 674 may change, and the corresponding pressure sensor 660 in the set of pressure sensors 630 coupled to the fluid gap 674 by fluidic connection 640 may be configured to sense a pressure change. The pressure change detected by pressure sensor 660 may be used, at least in part, in some embodiments to determine a force acting on the protrusion 622 based on contact with the environment. When considered across the set of pressure sensing units (each of which includes a fluid gap 674, a fluidic connection 640 and a pressure sensor 660), a spatial distribution of forces acting on the foot sensor from the environment may be determined.

It should be appreciated that the tactile sensing units described in connection with FIGS. 5A-5B and 6A-6B are examples in which the sensing transducer (e.g., magnetic sensor 512, pressure sensor 660) is provided out of the load path of the force applied to the set of protrusions of the tread. Rather, the deformation of a flexure associated with the set of protrusions is indirectly sensed by monitoring a change in a magnetic field or a pressure signal, respectively. Because the sensor transducer is not directly loaded, the foot sensor may be more robust to the large forces and impacts experienced by a robotic foot. It should be appreciated that foot sensors including other types of tactile sensing units are also contemplated as embodiments of the present disclosure. For example, the passive sensing units in the tread may be configured to create an optical, magnetic, inductive, capacitive, or other target that moves in response to forces applied to the tread, with the displacement being measured by an appropriate type of active sensor.

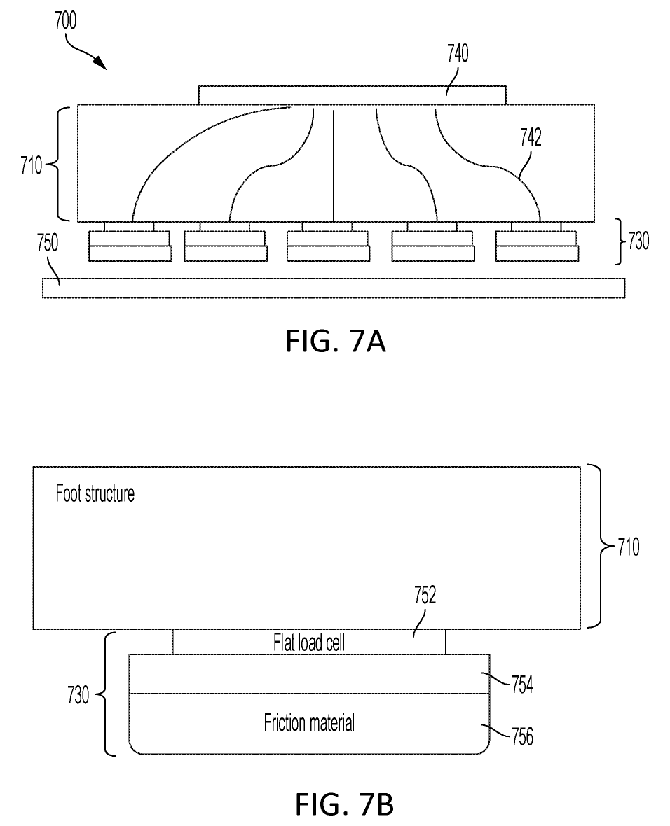

FIG. 7A schematically illustrates a robotic foot sensor 700 including strain gauge units, in accordance with some embodiments of the present disclosure. As shown, robotic foot sensor 700 includes a foot structure 710 coupled to a set of load cell units 730 configured to detect contact forces with the environment, such as the ground 750. The set of load cell units 730 may be electrically coupled via a set of wires 742 to a set of amplifiers 740. In some embodiments, the set of amplifiers 740 may be arranged on a printed circuit board (PCB). In some embodiments, the set of load cell units 730 includes a set of full bridge load cells.

As shown in FIG. 7B, each load cell unit 730 may include a friction element 756, a substrate 754 (e.g., a force plate), and a load cell 752 (e.g., a flat load cell). As the friction element 756 contacts a surface (e.g., ground 750), the force applied to the friction element 756 displaces the substrate 754 by an amount that is sensed by the load cell 752, which generates a force signal that is provided to one or more amplifiers 740. The friction element 756 may be configured to tolerate wear and tear from interaction with the environment, and the substrate 754 may be configured to have stable/linear elastic and/or thermal properties suitable for sensing forces normal to the load cell unit 730, while having relative immunity to sensing shear forces. For instance, load cell unit 730 may be implemented, at least in part, using a double bending beam or by making a moment connection between the load cell 752 and substrate 754. Inclusion of a separate friction element 756 and substrate 754 having different properties may, in some embodiments, permit the inclusion of more widely available materials in load cell unit 730 than if a single material having all of the desired properties (e.g., high wear and tear and stable/reliable sensing of normal but not shear forces) was used. When considered across the set of strain gauge units (each of which includes a load cell unit 730, a wire 742 and an amplifier 740), a spatial distribution of forces acting on the foot sensor from the environment may be determined.

The inventors have recognized and appreciated that reliable contact sensing may be important for robotic foot sensors. However, in some instances, using only tactile sensing techniques based on deformation of a flexure such as a polymer may not provide sufficiently reliable contact sensing (e.g., due to material creep, etc.). Some embodiments of the present disclosure relate to a foot sensor including multiple different types of sensing units. For instance, in some embodiments, the output of a first set of sensing units (e.g., a small set of load cell sensors) may be used to correct measurements from a second set of sensing units (e.g., a tactile sensing array). As an example, the output of the first set of sensing units may be used to correct for hysteresis exhibited in the set of tactile sensing units.

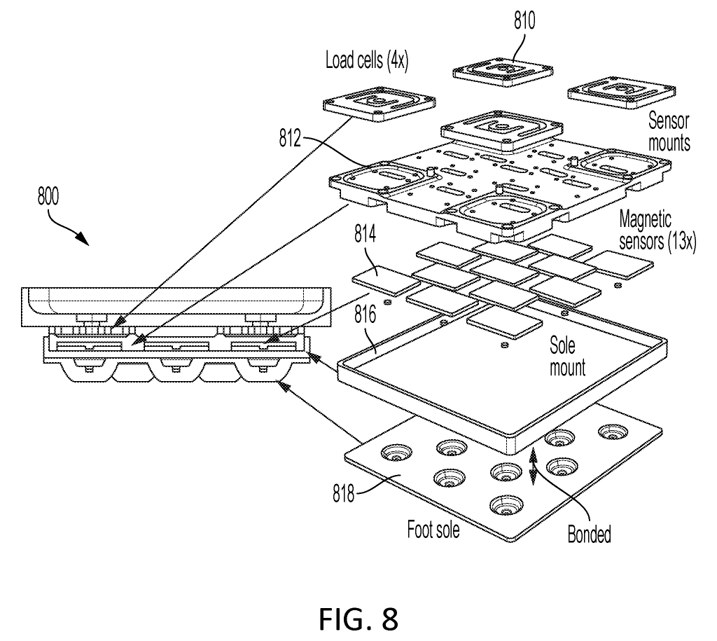

FIG. 8 provides an example of a robotic foot sensor 800 that includes a first set of sensing units configured to sense using a first sensing modality and a second set of sensing units configured to sense forces using a second sensing modality. The first set of sensing units may be configured to sense the contact forces on foot sensor (e.g., using load cell sensors) and the second set of sensing units may be configured as a tactile sensing array to sense the forces on the robotic foot sensor (e.g., using magnetic sensors, pressure sensors, inductive sensors, capacitive sensors or any combination thereof) by detecting the deformation of a flexure. A robotic foot sensor incorporating both types of sensing elements may have some advantages compared with robotic foot sensor designs that only incorporate a single type of sensing element. For example, a coarse array of a first type of tactile sensors (e.g., load cells) may be used to detect contact with high reliability and a finer array of a second type of tactile sensors (e.g., magnetic sensors) may be used to provide a whole force distribution and/or slip detection capability for the foot sensor.

In the example of FIG. 8, the first set of sensing units are implemented as magnetic sensors and the second set of sensing units are implemented as load cell sensors. The load cell sensors and the magnetic sensors of robotic foot sensor 800 are arranged in a stacked configuration with the load cell sensors being arranged between the magnetic sensors and the foot structure. As shown, foot sensor 800 includes tread 818 (e.g., foot sole) including a set of protrusions, at least some of which (e.g., all) include a magnet arranged therein. The tread 818 is coupled to a sole mount 816 (e.g., a rigid structure) within which a substrate 812 is arranged. Substrate 812 may include a set of magnetic sensors 814 configured to sense changes in a magnetic field generated by the magnets arranged within tread 818 when in contact with the environment. Although not shown in FIG. 8, it should be appreciated that the magnetic sensors may be associated with magnetic shielding components as described in connection with the magnetic sensors in FIGS. 5A and 5B. Foot sensor 800 further includes a set of load cells 810 coupled to the substrate 812 and configured to directly sense forces applied to the foot sensor 800 by the environment.

In some embodiments, the number of sensing elements in the first set may be different than the number of sensing elements in the second set. For example, robotic foot sensor 800 includes a set of four load cells 810 and a set of thirteen magnetic sensors 814. It should be appreciated, however, that any suitable number of sensing elements may be included in the first set and the second set. In some embodiments, multiple types of indirect tactile sensors may be used (e.g., magnetic sensors combined with inductive sensors). In some embodiments, more than two types of tactile sensors may be used (e.g., a combination of load cells, magnetic sensors and inductive sensors).

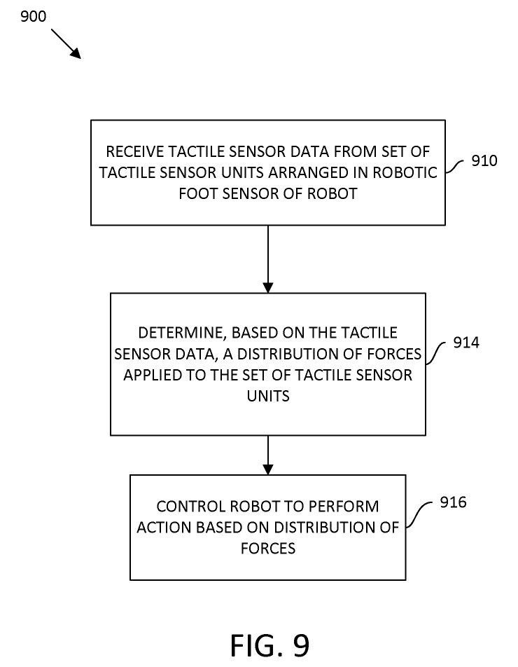

FIG. 9 is a flowchart of a process 900 for sensing forces applied to a robotic foot of a robot, in accordance with some embodiments of the present disclosure. Process 900 may begin in act 910, where tactile sensor data is received from a set of tactile sensor units arranged in a robotic foot sensor of a robot (e.g., a legged robot such as a humanoid robot). For example, the robotic foot sensor may include one or more types of tactile sensor units, examples of which are described herein. As a flexure coupled to a tread in which passive sensing elements are arranged is deformed through contact of the tread with the robot’s environment, the corresponding active sensors in the tactile sensor units are configured to sense a change in a physical quantity (e.g., magnetic field, electric field, pressure, inductance, capacitance, etc.), which corresponds to a displacement of a flexure coupled to the tread. Process 900 may then proceed to act 914, where a distribution of forces applied to the set of tactile sensor units is determined based, at least in part, on the tactile sensor data received in act 910. For instance, the output of the active sensors in the set of tactile sensor units may be processed to determine the distribution of forces on the robotic foot sensor. Process 900 may then proceed to act 916, where the robot is controlled (e.g., to perform a movement, maintain balance, perform a task, etc.) based, at least in part, on the distribution of forces determined in act 914. For instance, the force distribution data from the robotic foot sensor may be provided to a robotic controller configured to control torque applied at the joints of the robot. By providing the controller with a rich set of force information experienced by the robotic foot, the robot may be better able to maintain balance and/or perform fluid movements. As an example, by analyzing the distribution of forces applied on the foot sensor, it may be determined whether a portion of the robotic foot is slipping on a surface, and the robot may be controlled to take corrective action to reduce or prevent the slipping by making adjustments to the robot’s posture.

A number of implementations have been described. Nevertheless, it will be understood that various modifications may be made without departing from the spirit and scope of the disclosure.

1. A robotic foot sensor, comprising:
a member including a set of passive sensing elements; and
a set of active sensors communicatively coupled to the set of passive sensing elements.

2. The robotic foot sensor of claim 1, wherein the set of active sensors is arranged outside of a load path experienced by the set of passive sensing elements.

3. The robotic foot sensor of claim 1, further comprising:
an inertial measurement unit; and
at least one computer processor configured to characterize an interaction of a robotic foot including the robotic foot sensor and a surface based, at least in part, on a first output of the inertial measurement unit and a second output of the set of active sensors.

4. The robotic foot sensor of claim 3, wherein the interaction of the robotic foot and the surface comprises a determination of whether the robotic foot is slipping on the surface.

5. The robotic foot sensor of claim 3, wherein the interaction of the robotic foot and the surface comprises a determination of whether the robotic foot has contacted an object and/or a partial foothold on the surface.

6. The robotic foot sensor of claim 1, wherein the member includes a set of protrusions, each protrusion in the set of protrusions including a passive sensing element of the set of passive sensing elements.

7. The robotic foot sensor of claim 6, wherein the set of protrusions is arranged in an array pattern on a surface of the member.

8. The robotic foot sensor of claim 6, wherein the set of protrusions is arranged in a staggered pattern on a surface of the member.

9. The robotic foot sensor of claim 6, wherein the set of protrusions is arranged along an edge portion of the member.

10. The robotic foot sensor of claim 1, wherein the member comprises a polymer.

11. The robotic foot sensor of claim 1, wherein the member is configured to be separable from the set of active sensors.

12. The robotic foot sensor of claim 1, further comprising a rigid plate arranged between the set of passive sensing elements and the set of active sensors.

13. The robotic foot sensor of claim 1, wherein
the set of passive sensing elements includes a set of magnets arranged in the member, and
the set of active sensors comprises a set of magnetic sensors.

14. The robotic foot sensor of claim 13, wherein the member includes a set of protrusions, each protrusion in the set of protrusions including a magnet in the set of magnets.

15. The robotic foot sensor of claim 13, wherein the set of magnetic sensors includes a set of Hall sensors.

16. The robotic foot sensor of claim 13, wherein the set of magnetic sensors is configured to sense a change in a magnetic field generated by the set of magnets in response to deformation of a flexure coupled to the member.

17. The robotic foot sensor of claim 13, further comprising:
a magnetic shield formed around at least a portion of each magnet in the set of magnets.

18. The robotic foot sensor of claim 13, further comprising:
a magnetic shield formed around at least a portion of the set of magnetic sensors.

19. The robotic foot sensor of claim 1, wherein
the set of passive sensing elements includes a set of fluid gaps arranged in the member, and
the set of active sensors comprises a set of pressure sensors communicatively coupled to the set of fluid gaps.

20. The robotic foot sensor of claim 19, wherein the member includes a set of protrusions, each protrusion in the set of protrusions including a fluid gap in the set of fluid gaps.

21. The robotic foot sensor of claim 19, wherein the set of fluid gaps comprises a set of air gaps.

22. The robotic foot sensor of claim 19, wherein the set of pressure sensors is configured to sense a change in a pressure within the set of fluid gaps in response to deformation of a flexure coupled to the member.

23. The robotic foot sensor of claim 19, further comprising a printed circuit board on which the set of pressure sensors is arranged.

24. The robotic foot sensor of claim 1, wherein
the set of passive sensing elements includes a set of metal pieces arranged in the member, and
the set of active sensors comprises a set of coils communicatively coupled to the set of metal pieces.

25. The robotic foot sensor of claim 24, wherein the member includes a set of protrusions, each protrusion in the set of protrusions including a metal piece in the set of metal pieces.

26. The robotic foot sensor of claim 23, wherein the set of active sensors is configured to sense a change in inductance created in response to deformation of a flexure coupled to the member.

27. The robotic foot sensor of claim 23, wherein the set of active sensors is configured to sense a change in capacitance created in response to deformation of a flexure coupled to the member.

28. The robotic foot sensor of claim 1, wherein
the set of passive sensing elements includes a set of load cells, and
the set of active sensors comprises a set of amplifiers coupled to the set of load cells.

29. The robotic foot sensor of claim 28, further comprising a set of friction elements coupled to the set of load cells.

30. The robotic foot sensor of claim 29, wherein each load cell in the set of load cells includes a substrate coupled to a friction element in the set of friction elements.

31. The robotic foot sensor of claim 28, wherein the set of load cells comprises a set of full bridge load cells.

32. The robotic foot sensor of claim 1, wherein
the set of passive sensing elements includes first tactile sensing elements having a first sensing modality and second tactile sensing elements having a second sensing modality different from the first sensing modality.

33. The robotic foot sensor of claim 32, wherein the first tactile sensing elements comprise a set of load cells.

34. The robotic foot sensor of claim 33, wherein the second tactile sensing elements comprise a set of magnets.

35. The robotic foot sensor of claim 33, wherein the second tactile sensing elements comprise a set of fluid gaps arranged in the member.

36. The robotic foot sensor of claim 33 wherein a number of load cells in the set of load cells is less than a number of second tactile sensing elements.

37. The robotic foot sensor of claim 33, wherein a first portion of the set of active sensors is arranged between the set of load cells and the second tactile sensing elements.

38. The robotic foot sensor of claim 37, wherein the first portion of the set of active sensors comprises a set of magnetic sensors.

39. The robotic foot sensor of claim 32, further comprising a sole mount arranged between the first tactile sensing elements and the second tactile sensing elements, the sole mount mechanically coupled to the member.

40. The robotic foot sensor of claim 1, wherein the member comprises a tread.

41. A method of sensing forces applied to a robotic foot of a robot, the method comprising:
receiving, by set of active sensors communicatively coupled to a set of passive sensing elements arranged in a member, tactile sensor data; and
determining, based on the tactile sensor data, a distribution of forces applied to the set of passive sensing elements by an environment in contact with the member.

42. The method of claim 41, further comprising:
controlling the robot to perform an action based, at least in part, on the distribution of forces.

43. The method of claim 41, wherein the set of active sensors are arranged outside of a load path experienced by the set of passive sensing elements.

44. The method of claim 41, further comprising:
characterizing, by at least one computer processor, an interaction of the robotic foot and a surface based, at least in part, on a first output of an inertial measurement unit and a second output of the set of active sensors; and
controlling the robot to perform an action based, at least in part on the interaction of the robotic foot and the surface.

45. The method of claim 44, wherein characterizing the interaction of the robotic foot and the surface comprises determining whether the robotic foot is slipping on the surface.

46. The method of claim 44, wherein characterizing the interaction of the robotic foot and the surface comprises determining whether the robotic foot has contacted an object and/or a partial foothold on the surface.

47. The method of claim 41, wherein
the set of passive sensing elements includes first tactile sensing elements having a first sensing modality and second tactile sensing elements having a second sensing modality different from the first sensing modality.

48. A robotic foot for a legged robot, the robotic foot comprising:
a robotic foot structure including a set of active sensors; and
a member coupled to the robotic foot structure, the member including a set of passive sensing elements communicatively coupled to the set of active sensors.

49. The robotic foot of claim 48, wherein the set of active sensors is arranged outside of a load path experienced by the set of passive sensing elements.

50. The robotic foot of claim 48, further comprising:
an inertial measurement unit; and
at least one computer processor configured to characterize an interaction of the robotic foot and a surface based, at least in part, on a first output of the inertial measurement unit and a second output of the set of active sensors.

51. The robotic foot of claim 50, wherein the interaction of the robotic foot and the surface comprises a determination of whether the robotic foot is slipping on the surface.

52. The robotic foot of claim 50, wherein the interaction of the robotic foot and the surface comprises a determination of whether the robotic foot has contacted an object and/or a partial foothold on the surface.

53. The robotic foot of claim 48, wherein the member includes a set of protrusions, each protrusion in the set of protrusions including a passive sensing element of the set of passive sensing elements.

54. The robotic foot of claim 53, wherein the set of protrusions is arranged in an array pattern on a surface of the member.

55. The robotic foot of claim 53, wherein the set of protrusions is arranged in a staggered pattern on a surface of the member.

56. The robotic foot of claim 53, wherein the set of protrusions is arranged along an edge portion of the member.

57. The robotic foot of claim 48, wherein the member comprises a polymer.

58. The robotic foot of claim 48, wherein the member is configured to be separable from the robotic foot structure.

59. The robotic foot of claim 48, further comprising a rigid plate arranged between the set of passive sensing elements and the set of active sensors.

60. The robotic foot of claim 48, wherein
the set of passive sensing elements includes a set of magnets arranged in the member, and
the set of active sensors comprises a set of magnetic sensors.

61. The robotic foot of claim 60, wherein the member includes a set of protrusions, each protrusion in the set of protrusions including a magnet in the set of magnets.

62. The robotic foot of claim 60, wherein the set of magnetic sensors includes a set of Hall sensors.

63. The robotic foot of claim 60, wherein the set of magnetic sensors is configured to sense a change in a magnetic field generated by the set of magnets in response to deformation of a flexure coupled to the member.

64. The robotic foot of claim 60, further comprising:
a magnetic shield formed around at least a portion of each magnet in the set of magnets.

65. The robotic foot of claim 60, further comprising:
a magnetic shield formed around at least a portion of the set of magnetic sensors.

66. The robotic foot of claim 48, wherein
the set of passive sensing elements includes a set of fluid gaps arranged in the member, and
the set of active sensors comprises a set of pressure sensors communicatively coupled to the set of fluid gaps.

67. The robotic foot of claim 66, wherein the member includes a set of protrusions, each protrusion in the set of protrusions including a fluid gap in the set of fluid gaps.

68. The robotic foot of claim 66, wherein the set of fluid gaps comprises a set of air gaps.

69. The robotic foot of claim 66, wherein the set of pressure sensors is configured to sense a change in a pressure within the set of fluid gaps in response to deformation of a flexure coupled to the member.

70. The robotic foot of claim 66, further comprising a printed circuit board on which the set of pressure sensors is arranged.

71. The robotic foot of claim 48, wherein
the set of passive sensing elements includes a set of metal pieces arranged in the member, and
the set of active sensors comprises a set of coils communicatively coupled to the set of metal pieces.

72. The robotic foot of claim 71, wherein the member includes a set of protrusions, each protrusion in the set of protrusions including a metal piece in the set of metal pieces.

73. The robotic foot of claim 71, wherein the set of active sensors is configured to sense a change in inductance created in response to deformation of a flexure coupled to the member.

74. The robotic foot of claim 71, wherein the set of active sensors is configured to sense a change in capacitance created in response to deformation of a flexure coupled to the member.

75. The robotic foot of claim 48, wherein
the set of passive sensing elements includes a set of load cells, and
the set of active sensors comprises a set of amplifiers coupled to the set of load cells.

76. The robotic foot of claim 75, further comprising a set of friction elements coupled to the set of load cells.

77. The robotic foot of claim 76, wherein each load cell in the set of load cells includes a substrate coupled to a friction element in the set of friction elements.

78. The robotic foot of claim 75, wherein the set of load cells comprises a set of full bridge load cells.

79. The robotic foot of claim 48, wherein
the set of passive sensing elements includes first tactile sensing elements having a first sensing modality and second tactile sensing elements having a second sensing modality different from the first sensing modality.

80. The robotic foot of claim 79, wherein the first tactile sensing elements comprise a set of load cells.

81. The robotic foot of claim 79, wherein the second tactile sensing elements comprise a set of magnets.

82. The robotic foot of claim 79, wherein the second tactile sensing elements comprise a set of fluid gaps arranged in the member.

83. The robotic foot of claim 80, wherein a number of load cells in the set of load cells is less than a number of second tactile sensing elements.

84. The robotic foot of claim 80, wherein a first portion of the set of active sensors is arranged between the set of load cells and the second tactile sensing elements.

85. The robotic foot of claim 84, wherein the first portion of the set of active sensors comprises a set of magnetic sensors.

86. The robotic foot of claim 79, further comprising a sole mount arranged between the first tactile sensing elements and the second tactile sensing elements, the sole mount mechanically coupled to the member.

87. The robotic foot of claim 48, wherein the member comprises a tread.
